(19) United States
(12) Patent Application Publication
(10) Pub. No.: US 2023/0234221 A1
(43) Pub. Date: Jul. 27, 2023

(54) ROBOT AND METHOD FOR CONTROLLING THEREOF

(71) Applicant: SAMSUNG ELECTRONICS CO., LTD., Suwon-si (KR)

(72) Inventors: Heechang RYU, Suwon-si (KR); Jaechul YANG, Suwon-si (KR); Hyungrai OH, Suwon-si (KR); Yeonho LEE, Suwon-si (KR); Hyunwoo PARK, Suwon-si (KR); Kookjin YEO, Suwon-si (KR); Jongsun LEE, Suwon-si (KR)

(73) Assignee: SAMSUNG ELECTRONICS CO., LTD., Suwon-si (KR)

(21) Appl. No.: 18/128,009

(22) Filed: Mar. 29, 2023

Related U.S. Application Data
(63) Continuation of application No. PCT/KR2023/000785, filed on Jan. 17, 2023.

(30) Foreign Application Priority Data
Jan. 17, 2022 (KR) 10-2022-0006815

(51) Int. Cl. B25J 9/16

(52) U.S. Cl. CPC B25J 9/163; G05B 2219/39001; G05B 2219/40305

(57) ABSTRACT

A robot and a controlling method thereof are provided. The robot includes a memory configured to store at least one instruction; and at least one processor configured to execute the at least one instruction to: based on detecting a user interaction, acquire information on a behavior tree corresponding to the user interaction, and perform an action corresponding to the user interaction based on the information on the behavior tree, wherein the behavior tree includes a node for controlling a dialogue flow between the robot and a user.

### CROSS-REFERENCE TO RELATED APPLICATIONS

This application is a continuation of International Application No. PCT/KR2023/000785, filed on Jan. 17, 2023, which is based on and claims the priority benefit of Korean Patent Application No. 10-2022-0006815, filed on Jan. 17, 2022, in the Korean Intellectual Property Office, the disclosures of which are incorporated by reference herein in their entirety.

### BACKGROUND

### 1. Field

The disclosure relates to a robot apparatus and a controlling method thereof, and more particularly, to a robot that can control an action of the robot according to a behavior tree corresponding to a user interaction, and a controlling method thereof.

### 2. Description of Related Art

A robot may need a longtime action for performing a task desired by a user, and accordingly, while performing a task, a robot should vary an action according to an environmental change or a user need, or vary a dialogue with a user. Also, a robot may respond to an input regarding various modalities, and when providing a response to a user interaction, a robot needs to perform actions simultaneously by using several modalities. That is, a robot may need longtime actions for performing a task desired by a user, and thus there is a need to optimize the overall task performance to suit an environmental change.

A robot in the related art uses a behavior tree when performing an action to perform a task regarding a user interaction. A behavior tree expresses a logic regarding a behavior principle of a robot in the form of a tree, and by virtue of this, a robot can constitute a plurality of actions hierarchically, and perform complex actions.

However, in the past, a feature controlling a dialogue flow between a user and a robot, and a behavior tree were implemented separately, and accordingly, it is difficult to instantaneously provide an appropriate response according to an environmental change of a robot through various modalities.

### SUMMARY

Provided are a robot including a node for controlling a dialogue flow between a user and the robot inside a behavior tree for performing a task corresponding to a user interaction to integrally implement a behavior tree and control of a dialogue flow, and a controlling method thereof.

According to an aspect of the disclosure, a robot includes: a memory configured to store at least one instruction; and at least one processor configured to execute the at least one instruction to: based on detecting a user interaction, acquire information on a behavior tree corresponding to the user interaction, and perform an action corresponding to the user interaction based on the information on the behavior tree, wherein the behavior tree includes a node for controlling a dialogue flow between the robot and a user.

The memory may include: a blackboard area configured to store data including data detected by the robot, data regarding the user interaction, and data regarding the action performed by the robot, and the at least one processor may be further configured to execute the at least one instruction to acquire the information on the behavior tree corresponding to the user interaction based on the data stored in the blackboard area.

The user interaction may include a user voice, and the at least one processor may be further configured to execute the at least one instruction to: acquire information on a user intent corresponding to the user voice and information on a slot for performing an action corresponding to the user intent, determine whether the information on the slot is sufficient for performing a task corresponding to the user intent, based on determining that the information on the slot is insufficient for performing the task corresponding to the user intent, acquire information on an additional slot necessary for performing the task corresponding to the user intent, and store, in the blackboard area, the information on the user intent, the information on the slot, and the information on the additional slot.

The at least one processor may be further configured to execute the at least one instruction to: convert the information on the slot into information in a form that can be interpreted by the robot, and acquire information on the additional slot based on a dialogue history or through an additional inquiry and response operation.

The additional inquiry and response operation may include a re-asking operation including an inquiry regarding the slot for performing the task corresponding to the user intent, a selection operation configured to select one of a plurality of slots, and a confirmation operation configured to confirm whether the slot is the slot selected by the user, and the at least one processor may be further configured to execute the at least one instruction to: store information on the additional inquiry and response operation in the blackboard area, and acquire information on the behavior tree including a node for controlling a dialogue flow between the robot and the user based on the additional inquiry and response operation.

The at least one processor may be further configured to execute the at least one instruction to, based on either the task being successfully performed or a user feedback, learn whether to acquire the information on the additional slot based on the dialogue history.

The behavior tree may include at least one of: a learnable selector node that is trained to select an optimal sub tree/node among a plurality of sub trees/nodes, a learnable sequence node that is trained to select an optimal order of the plurality of sub trees/nodes, or a learnable parallel node that is trained to select optimal sub trees/nodes that can perform simultaneously among the plurality of sub trees/nodes.

The at least one processor may be further configured to execute the at least one instruction to train the learnable selector node, the learnable sequence node, and the learnable parallel node based on a task learning policy, and the task learning policy may include information on an evaluation method, an update cycle, and a cost function.

According to an aspect of the disclosure, a method of controlling a robot, includes: based on detecting a user interaction, acquiring information on a behavior tree corresponding to the user interaction; and performing an action corresponding to the user interaction based on the information on the behavior tree, wherein the behavior tree includes a node for controlling a dialogue flow between the robot and a user.

The acquiring information on the behavior tree corresponding to the user interaction may include acquiring information on the behavior tree corresponding to the user interaction based on data stored in a blackboard memory area of the robot, and the data stored in the blackboard memory area of the robot may include data detected by the robot, data regarding the user interaction, and data regarding the action performed by the robot.

The user interaction may include a user voice, and the method may further include: acquiring information on a user intent corresponding to the user voice and information on a slot for performing an action corresponding to the user intent; determining whether the information on the slot is sufficient for performing a task corresponding to the user intent; based on determining that the information on the slot is insufficient for performing the task corresponding to the user intent, acquiring information on an additional slot necessary for performing the task corresponding to the user intent; and storing, in the blackboard memory area, the information on the user intent, the information on the slot, and the information on the additional slot.

The acquiring information on an additional slot may include: converting the information on the slot into information in a form that can be interpreted by the robot; and acquiring information on the additional slot based on a dialogue history or through an additional inquiry and response operation.

The additional inquiry and response operation may include a re-asking operation including an inquiry regarding the slot for performing the task corresponding to the user intent, a selection operation configured to select one of a plurality of slots, and a confirmation operation configured to confirm whether the slot is the slot selected by the user, and the acquiring information on the behavior tree may further include: storing, in the blackboard memory area, information on the additional inquiry and response operation; and acquiring information on the behavior tree including a node for controlling a dialogue flow between the robot and the user based on the additional inquiry and response operation.

The method may further include, based on either the task being successfully performed or a user feedback, learning whether to acquire the information on the additional slot based on the dialogue history.

The behavior tree may include at least one of: a learnable selector node that is trained to select an optimal sub tree/node among a plurality of sub trees/nodes, a learnable sequence node that is trained to select an optimal order of the plurality of sub trees/nodes, or a learnable parallel node that is trained to select optimal sub trees/nodes that can perform simultaneously among the plurality of sub trees/nodes.

According to the one or more embodiments of the disclosure as described above, a robot is controlled by systemically combining a behavior tree and control of a dialogue flow, and accordingly, a robot becomes capable of performing a task or providing a response more actively to suit an environmental change or a change in a user's needs.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of a robot according to an embodiment of the disclosure;

FIG. 2 is a block diagram illustrating a component for performing a task corresponding to a user interaction according to an embodiment of the disclosure;

FIG. 3 is a diagram for illustrating components included in a behavior tree learning module according to an embodiment of the disclosure;

FIG. 4 is a diagram for illustrating a learnable selector node according to an embodiment of the disclosure;

FIG. 5A to FIG. 5C are diagrams for illustrating a selector node that is trained according to passage of time according to an embodiment of the disclosure;

FIG. 6 is a graph for illustrating a value of a cost function according to time in a process of training a selector node according to an embodiment of the disclosure;

FIG. 7 is a diagram for illustrating a learnable sequence node according to an embodiment of the disclosure;

FIG. 8 is a diagram for illustrating a behavior tree determined by a behavior tree determination module according to an embodiment of the disclosure;

FIG. 9A and FIG. 9B are diagrams for illustrating data stored in a dialogue resource according to an embodiment of the disclosure;

FIG. 10 is a diagram for illustrating an NLG template according to an embodiment of the disclosure; and

FIG. 11 is a flow chart for illustrating a controlling method of a robot according to an embodiment of the disclosure.

### DETAILED DESCRIPTION

Hereinafter, various embodiments of the disclosure will be described. However, it should be noted that the various embodiments are not for limiting the technology of the disclosure to a specific embodiment, but they should be interpreted to include various modifications, equivalents, and/or alternatives of the embodiments of the disclosure.

Also, in the disclosure, expressions such as “have,” “may have,” “include,” and “may include” should be construed as denoting that there are such characteristics (e.g., elements such as numerical values, functions, operations, and components), and the expressions are not intended to exclude the existence of additional characteristics.

In addition, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including A, (2) including B, or (3) including A and B.

Further, the expressions “first,” “second,” and the like used in the disclosure may be used to describe various elements regardless of any order and/or degree of importance. Also, such expressions are used only to distinguish one element from another element, and are not intended to limit the elements. For example, a first user device and a second user device may refer to user devices that are different from each other, regardless of any order or degree of importance. For example, a first element may be called a second element, and a second element may be called a first element in a similar manner, without departing from the scope of the disclosure.

Also, the terms “a module,” “a unit,” “a part,” and the like used in the disclosure are for referring to elements performing at least one function or operation, and these elements may be implemented as hardware or software, or as a combination of hardware and software. Further, a plurality of “modules,” “units,” “parts,” and the like may be integrated into at least one module or chip and implemented as at least one processor, except when each of them has to be implemented as individual, specific hardware.

The description in the disclosure that one element (e.g., a first element) is “(operatively or communicatively) coupled with/to” or “connected to” another element (e.g., a second element) should be interpreted to include both the case where the one element is directly coupled to the another element, and the case where the one element is coupled to the another element through still another element (e.g., a third element). In contrast, the description that one element (e.g., a first element) is “directly coupled” or “directly connected” to another element (e.g., a second element) can be interpreted to mean that still another element (e.g., a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. The term “configured to” does not necessarily mean that a device is “specifically designed to” in terms of hardware. Instead, under some circumstances, the expression “a device configured to” may mean that the device “is capable of” performing an operation together with another device or component. For example, the phrase “a processor configured to perform A, B and, C” may mean a dedicated processor (e.g., an embedded processor) for performing the corresponding operations, or a generic-purpose processor (e.g., a CPU or an application processor) that can perform the corresponding operations by executing one or more software programs stored in a memory device.

In addition, the terms used in the disclosure are only used to describe certain embodiments of the disclosure, and are not intended to limit the scope of the other embodiments. Also, singular expressions may include plural expressions, unless defined obviously differently in the context. The terms used in the disclosure, including technical or scientific terms, may have meanings identical to those generally known to those of ordinary skill in the art described in the disclosure. Terms defined in general dictionaries among the terms used herein may be interpreted to have the same meaning as or a similar meaning to the contextual meaning in the related art. Unless otherwise defined, the terms used herein may not be interpreted to have an ideal or overly formal meaning. Depending on cases, even terms defined herein may not be interpreted to exclude the embodiments herein.

Hereinafter, the disclosure will be described in more detail with reference to the accompanying drawings. Also, with respect to the detailed description of the drawings, similar components may be designated by similar reference numerals.

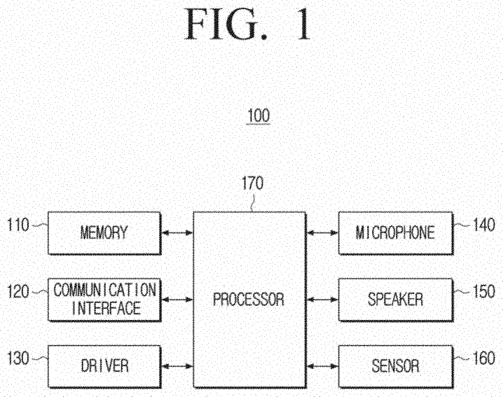

FIG. 1 is a block diagram illustrating a configuration of a robot according to an embodiment of the disclosure. Referring to FIG. 1, a robot 100 may include a memory 110, a communication interface 120, a driver 130, a microphone 140, a speaker 150, a sensor 160, and a processor 170. The robot 100 according to an embodiment of the disclosure may be a serving robot, but this is merely an example, and it may be service robots in various types. Also, the features of the robot 100 are not limited to the features illustrated in FIG. 1, and it is obvious that features obvious to a person skilled in the art can be added.

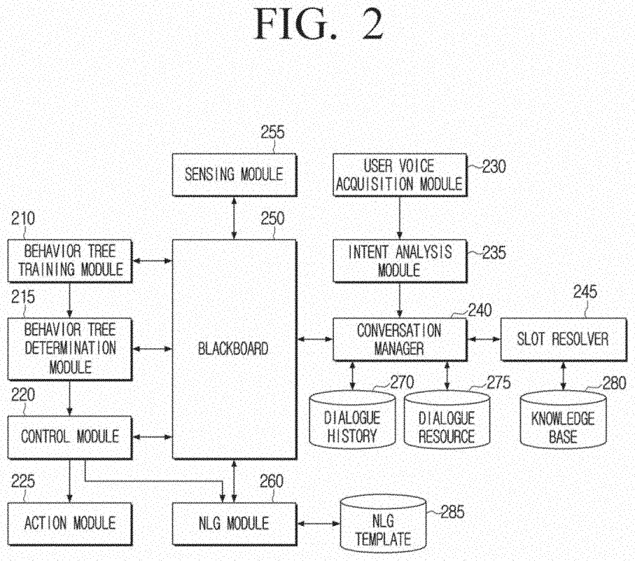

The memory 110 may include an operating system (OS) for controlling the overall operations of the components of the robot 100, and instructions or data related to the components of the robot 100. In particular, the memory 110 may include, as illustrated in FIG. 2, a behavior tree training module 210, a behavior tree determination module 215, a control module 220, an action module 225, a user voice acquisition module 230, an intent analysis module 235, a dialogue manager 240, a slot resolver 245, a sensing module 255, and a natural language generation (NLG) module 260, for integrating a behavior tree and control of a dialogue flow and performing a task.

Also, the memory 110 may include a blackboard 250 storing data detected by the robot 100, data regarding the user's interaction, and data regarding the action performed by the robot.

In addition, the memory 110 may include a dialogue history 270, a dialogue resource 275, a knowledge base 280, and an NLG template 285 for performing a dialogue between the user and the robot 100. The dialogue history 270, the dialogue resource 275, the knowledge base 280, and the NLG template 285 may be stored in the memory 110, but this is merely an example, and at least one of the dialogue history 270, the dialogue resource 275, the knowledge base 280, or the NLG template 285 may be stored in an external server.

The memory 110 may be implemented as a non-volatile memory (ex: a hard disc, a solid state drive (SSD), a flash memory), a volatile memory (it may include a memory inside the processor 170), etc.

The communication interface 120 may include at least one circuit, and perform communication with external devices or servers in various types. The communication interface 120 may include at least one of a Bluetooth Low Energy (BLE) module, a Wi-Fi communication module, a cellular communication module, a 3rd Generation (3G) mobile communication module, a 4th Generation (4G) mobile communication module, a 4th Generation Long Term Evolution (LTE) communication module, or a 5th Generation (5G) mobile communication module.

In particular, the communication interface 120 may receive information on a behavior tree including a learnable node from an external server. Also, the communication interface 120 may receive knowledge data from an external server storing a knowledge base.

The driver 130 is a component for performing various kinds of actions of the robot 100, for performing a task corresponding to a user interaction. For example, the driver 130 may include wheels moving (or driving) the robot 100, and a wheel driving motor rotating the wheels. Alternatively, the driver 130 may include motors for moving the head, the arm, or the hand of the robot 100. The driver 130 may include a motor driving circuit providing driving currents to various kinds of motors, and a rotation detection sensor detecting a rotation displacement and a rotation speed of a motor. Also, the driver 130 may include various components for controlling the robot's facial expressions, gazes, etc. (for example, a light emitting part outputting a light for expressing the face or a facial expression of the robot 100)

The microphone 140 may acquire a user's voice. The processor 170 may determine a task that the robot 100 has to perform based on a user voice acquired through the microphone 140. For example, the microphone 140 may acquire a user's voice requesting explanation of a product (“Please explain about the product”). Here, the processor 170 may control to provide various actions (e.g., an action of watching the product, etc.) and response messages (e.g., “The characteristic of this product is —”) for performing a task of explaining about the product. Alternatively, the processor 170 may control the display to display a response message explaining about the product.

The speaker 150 may output a voice message. For example, the speaker 150 may output a voice message corresponding to a sentence introducing the robot 100 (“Hello, I'm Samsung bot”). Also, the speaker 150 may output a voice message as a response message to a user voice.

The sensor 160 is a component for detecting the surrounding environment of the robot 100 or a user's state. As an example, the sensor 160 may include a camera, a depth sensor, and an inertial measurement unit (IMU) sensor. The camera is a component for acquiring an image that photographed the surroundings of the robot 100. The processor 170 may analyze a photographed image acquired through the camera, and recognize a user. For example, the processor 170 may input a photographed image into an object recognition model, and recognize a user included in the photographed image. Here, the object recognition model is an artificial neural network model trained to recognize an object included in an image, and it may be stored in the memory 110. The camera may include image sensors in various types. The depth sensor is a component for detecting an obstacle around the robot 100. The processor 170 may acquire a distance from the robot 100 to an obstacle based on a sensing value of the depth sensor. For example, the depth sensor may include a LiDAR sensor. Alternatively, the depth sensor may include a radar sensor and a depth camera. The IMU sensor is a component for acquiring posture information of the robot 100. The IMU sensor may include a gyro sensor and a geomagnetic sensor. Other than the above, the robot 100 may include various sensors for detecting the surrounding environment of the robot 100 or a user's state.

The processor 170 may be electronically connected with the memory 110, and control the overall functions and operations of the robot 100. When the robot 100 is driven, the processor 170 may load data for the modules stored in the non-volatile memory (e.g., the behavior tree training module 210, the behavior tree determination module 215, the control module 220, the action module 225, the user voice acquisition module 230, the intent analysis module 235, the dialogue manager 240, the slot resolver 245, the sensing module 255, and the NLG module 260) to perform various kinds of operations on the volatile memory. Here, loading means an operation of calling data stored in the non-volatile memory in the volatile memory and storing the data, so that the processor 170 can access the data.

In particular, the processor 170 may integrate a behavior tree and control of a dialogue flow, and perform a task corresponding to a user interaction. Specifically, if a user's interaction is detected, the processor 170 may acquire information on a behavior tree corresponding to the interaction for performing a task corresponding to the user's interaction, and perform an action for the interaction based on the information on the behavior tree. Here, the behavior tree may include a node for controlling a dialogue flow between the robot and the user. That is, the processor 170 may integrate the behavior tree and control of the dialogue flow, and perform a task corresponding to the user interaction. Detailed explanation in this regard will be made with reference to FIG. 2.

FIG. 2 is a block diagram illustrating a component for performing a task corresponding to a user interaction according to an embodiment of the disclosure.

The behavior tree training module 210 is a component to train a behavior tree for the robot 100 to perform a task. Here, the behavior tree expresses a logic regarding the behavior principle of the robot in a form of a tree, and it may be expressed through a hierarchical relation between a plurality of nodes and a plurality of actions. Here, the behavior tree may include a composite node, a decorator node, and a task node, etc. Here, the composite node may include a selector node performing actions until one of a plurality of actions succeeds, a sequence node performing a plurality of actions sequentially, and a parallel node performing a plurality of nodes in parallel.

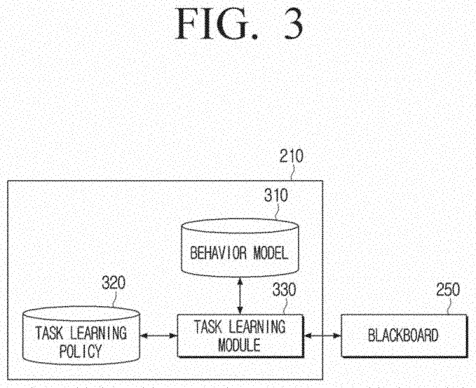

More detailed explanation regarding the behavior tree training module 210 will be made with reference to FIG. 3 to FIG. 8. The behavior tree training module 210 may include a behavior model 310, a task learning policy 320, and a task learning module 330.

The behavior model 310 stores a resource modeling the robot's action flow. In particular, the behavior model 310 may store resource information regarding a behavior tree (or a generalized behavior tree) before the robot 100 trains a behavior tree. A behavior tree according to an embodiment of the disclosure may include at least one of a learnable selector node, a learnable sequence node, or a learnable parallel node.

The task learning policy 320 may include information on an evaluation method, an update cycle, or a cost function for training a behavior tree. Here, the evaluation method is about whether to train such that a result output by a cost function becomes maximum or to train such that the result becomes minimum, the update cycle is about the evaluation cycle (e.g., the time/day/month/number of times, etc.) of the behavior tree, and the cost function is about a calculation method using data (or an event) stored in the blackboard by a task performed through the behavior tree.

The task learning module 330 may train a behavior tree by the task learning policy 320. In particular, the task learning module 330 may train at least one of a learnable selector node, a learnable sequence node, or a learnable parallel node included in a behavior tree. Specifically, the task learning module 330 may train the learnable selector node to select an optimal sub tree/node among a plurality of sub trees/nodes. Also, the task learning module 330 may train the learnable sequence node to select an optimal order of the plurality of sub trees/nodes. In addition, the task learning module 330 may train the learnable parallel node to select optimal sub trees/nodes that can perform tasks simultaneously among the plurality of sub trees/nodes.

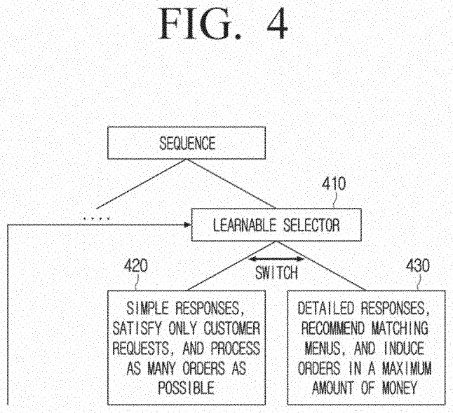

Hereinafter, a training method of various composite nodes will be described with reference to FIG. 4 to FIG. 7.

FIG. 4 is a diagram for illustrating a learnable selector node according to an embodiment of the disclosure. First, a behavior model 310 of a restaurant serving robot may store a behavior tree as illustrated in FIG. 4. Specifically, a learnable selector node 410 included in a behavior tree may include a plurality of sub nodes 420, 430. Here, the first sub node 420 may include an action of simple responses and satisfying only customer requests, and processing as many orders as possible, and the second sub node 430 may include an action of detailed responses and recommending matching menus, and inducing orders of a maximum amount of money. Here, the order of the first sub node 420 and the second sub node 430 may be changed according to time.

Also, the task learning module 330 may acquire a task learning policy as in Table 1 below as a task learning policy 320 for training a behavior tree.

TABLE 1
Task Learning Policy

| | |
|---|---|
| Evaluation Method | Maximize |
| Update Cycle | Day |
| Cost Function | Sales*0.5 + |
| | Customer Satisfaction*0.5 |

The task learning module 330 may train such that an optimal learnable selector node 410 is set according to the business hours based on the behavior tree illustrated in FIG. 4 and the task learning policy illustrated in Table 1.

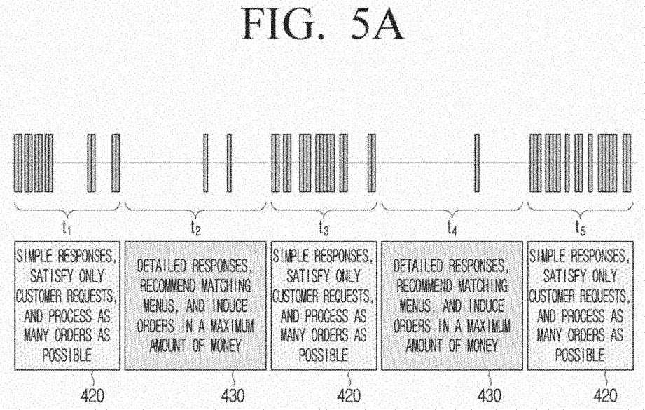

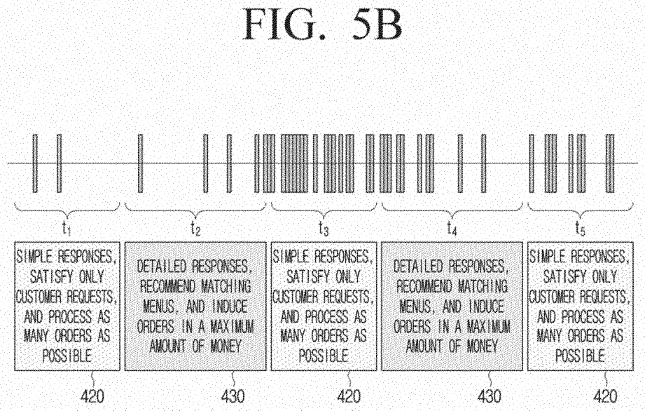

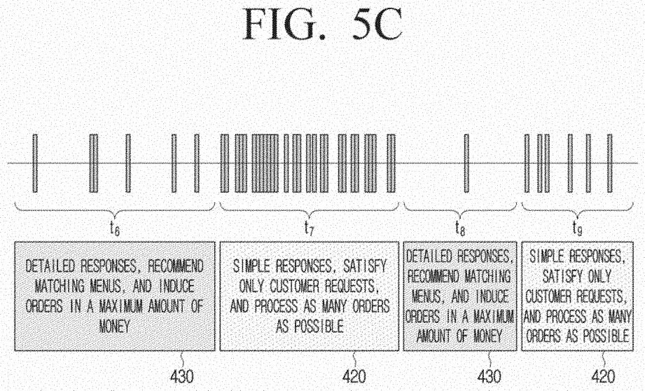

Specifically, the behavior tree (or, the generalized behavior tree) before training stored in the behavior model 310 may be a behavior tree trained by a general restaurant environment. FIG. 5A is a diagram illustrating nodes that are executed preferentially among sub nodes included in a learnable selector node according to business hours before training according to an embodiment of the disclosure. The bar illustrated in FIG. 5A to FIG. 5C may indicate the density (or the number of customers) of the restaurant.

For example, in the behavior tree before training, as illustrated in FIG. 5A, sub nodes may be arranged such that an action of the first sub node 420 is performed preferentially in the first business hour t1, and sub nodes may be arranged such that an action of the second sub node 430 is performed preferentially in the second business hour t2, and sub nodes may be arranged such that an action of the first sub node 420 is performed preferentially in the third business hour t3, and sub nodes may be arranged such that an action of the second sub node 430 is performed preferentially in the fourth business hour t4, and sub nodes may be arranged such that an action of the first sub node 420 is performed preferentially in the fifth business hour t5. That is, in the business hours t1, t3, t5 that are crowded with people, sub nodes may be arranged such that an action of the first sub node 420 is performed preferentially, and in the business hours t2, t4 that are not crowded with people, sub nodes may be arranged such that an action of the second sub node 430 is performed preferentially.

The task learning module 330 may train the behavior tree based on the customer satisfaction and the actual sales by a unit of one day.

FIG. 5B is a diagram illustrating nodes that are executed preferentially among sub nodes included in a learnable selector node according to business hours on the actual first business day according to an embodiment of the disclosure.

Specifically, on the first business day, the robot 100 may perform a task based on a behavior tree (i.e., the behavior tree as illustrated in FIG. 5A) before training. That is, in the behavior tree on the first business day, as illustrated in FIG. 5B, sub nodes may be arranged such that an action of the first sub node 420 is performed preferentially in the first business hour t1, and sub nodes may be arranged such that an action of the second sub node 430 is performed preferentially in the second business hour t2, and sub nodes may be arranged such that an action of the first sub node 420 is performed preferentially in the third business hour t3, and sub nodes may be arranged such that an action of the second sub node 430 is performed preferentially in the fourth business hour t4, and sub nodes may be arranged such that an action of the first sub node 420 is performed preferentially in the fifth business hour t5. That is, on the first business day, the robot 100 may operate similarly to the behavior tree before training regardless of the current density of customers and the satisfaction of customers. For example, the density of customers is low in the first business hour t1, but sub nodes may be arranged such that an action of the first sub node 420 is performed preferentially.

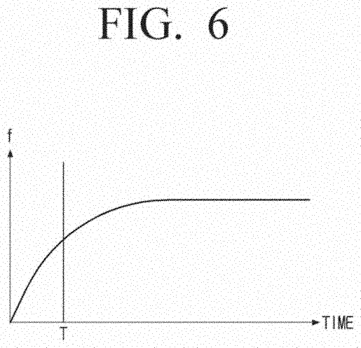

Here, the task learning module 330 may train the behavior tree based on a result value of a cost function calculated by the restaurant's sales and the customer satisfaction. That is, as illustrated in FIG. 6, the robot 100 may perform a task based on the behavior tree before training before a threshold time T, and then perform the task based on the trained behavior tree after the threshold time T. Also, the task learning module 330 may train the behavior tree until the result value f of the cost function reaches a threshold value. That is, the task learning module 330 may train by changing the order of the sub nodes included in the learnable selector node of the behavior tree until the result value f of the cost function reaches the threshold value.

FIG. 5C is a diagram illustrating nodes that are executed preferentially among sub nodes included in a learnable selector node according to business hours on the actual nth business day (e.g., the 100th day) according to an embodiment of the disclosure.

Specifically, on the 100th business day, the robot 100 may perform a task based on the behavior tree trained by the actual environment of the restaurant regardless of the behavior tree (i.e., the behavior tree as illustrated in FIG. 5A) before training. That is, in the behavior tree on the 100th business day, as illustrated in FIG. 5C, sub nodes may be arranged such that an action of the second sub node 430 is performed preferentially in the sixth business hour t6, and sub nodes may be arranged such that an action of the first sub node 420 is performed preferentially in the seventh business hour t7, and sub nodes may be arranged such that an action of the second sub node 430 is performed preferentially in the eighth business hour t8, and sub nodes may be arranged such that an action of the first sub node 420 is performed preferentially in the ninth business hour t9. That is, on the 100th business day, the robot 100 may operate based on the behavior tree trained according to the density of customers in the restaurant and the customer's satisfaction. For example, previously, the density of customers was low in the first business hour t1, and thus the robot 100 may arrange sub nodes such that an action corresponding to the second sub node 430 is performed preferentially.

In case the result value of the cost function reaches the threshold value, the task learning module 330 may change the learnable selector node included in the behavior tree to a selector node.

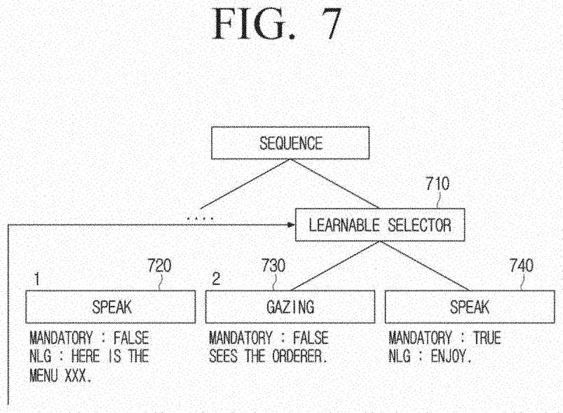

FIG. 7 is a diagram for illustrating a learnable sequence node according to an embodiment of the disclosure. First, the behavior model 310 of the restaurant serving robot may store a behavior tree as illustrated in FIG. 7. Specifically, a learnable sequence node 710 included in the behavior tree may include a plurality of sub nodes 720 to 740. Here, the first sub node 710 may include an action for explaining about menus, the second sub node 720 may include an action regarding the robot's gaze, and the third sub node 730 may include an action for a greeting for dining.

Also, the task learning module 330 may acquire a task learning policy as in Table 2 below as a task learning policy 320 for training the behavior tree.

TABLE 2
Task Learning Policy

| | |
|---|---|
| Evaluation Method | Maximize |
| Update Cycle | Day |
| Cost Function | Reputation Score |
| | (Total Reputation Score) |

The task learning module 330 may train the learnable sequence node 710 such that the plurality of sub nodes 720 to 740 become optimal based on the behavior tree illustrated in FIG. 7 and the task learning policy illustrated in Table 2. Here, the task learning module 330 may acquire a reputation score by changing the order of the first sub node 710 and the second sub node 720, and train the learnable sequence node 710 with the order having the highest reputation score. Here, when the reputation score reaches the threshold value, the task learning module 330 may change the learnable sequence node 710 to a sequence node.

As described in FIG. 4 to FIG. 7, by training learnable composite nodes included in a behavior tree, the robot 100 becomes capable of performing a task according to a behavior tree optimized for the actual business environment of the restaurant.

Explaining about FIG. 2 again, the behavior tree determination module 215 may determine a behavior tree corresponding to a user interaction based on data stored in the blackboard 250. Specifically, the behavior tree determination module 215 may determine a behavior tree corresponding to an interaction based on data detected by the robot 100 by the sensing module 255, data regarding a user's interaction, and data regarding an action performed by the robot 100 stored in the blackboard 250, and acquire information on the determined behavior tree.

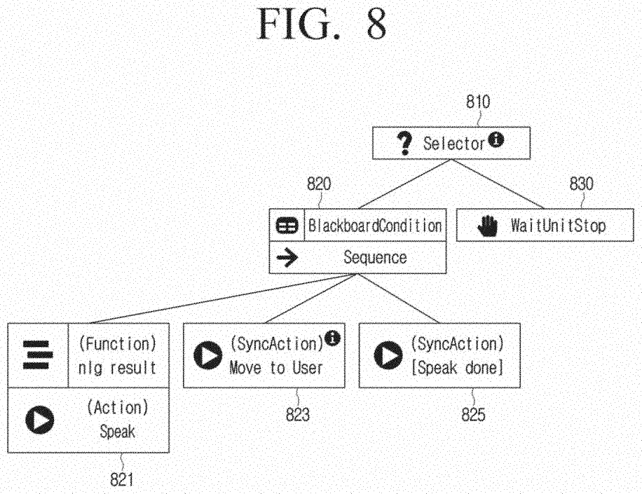

For example, if a user voice “Come here” is input, the behavior tree determination module 215 may determine the behavior tree illustrated in FIG. 8 based on information on the location of the robot and information on the user voice stored in the blackboard 250. Here, the behavior tree may include a selector node 810, a sequence node 820 according to BlackboardCondition as the first sub node of the selector node 810, a WaitUntilStop node 830 as the second sub node of the selector node 810, a speak node 821 for performing a first action as a sub node of the sequence node 820, a move to user node 823 for performing a second action as a sub node of the sequence node 820, and a speak done node 825 for performing a third action as a sub node of the sequence node 820.

In particular, the behavior tree determination module 215 may determine a behavior tree based on information on a user intent acquired by a user voice in a user's interaction, a slot for performing a task corresponding to the user intent, etc. Here, the behavior tree may include a node for controlling a dialogue flow between the robot 100 and the user. For example, in the node for controlling a dialogue flow between the robot 100 and the user, at least one of a node for performing a re-asking operation of inquiring about a slot necessary for performing a task corresponding to the user intent, a node for performing a selection operation for selecting one of a plurality of slots, or a node for performing a confirmation operation of confirming whether the slot is the slot selected by the user may be included.

The control module 220 may perform a task corresponding to the user interaction based on the acquired behavior tree. Here, the control module 220 may control the action module 225 and the NLG module 260 based on the determined behavior tree and the data stored in the blackboard 250.

The control module 220 may perform an action corresponding to a node included in the behavior tree by control by the control module 220. Specifically, the action module 225 may control the driver 130 to perform an action corresponding to a node. For example, the action module 225 may perform a driving action by using wheels and a wheel driving motor, and perform actions regarding the head, the arm, or the hand by using motors. Also, the action module 225 may control the light emitting part, etc. expressing the face or a facial expression of the robot 100 and perform an action of changing the facial expression of the robot 100.

In addition, the robot 100 may acquire a user voice in a user interaction, and perform a task based on the user voice and perform a dialogue with the user.

Specifically, the user voice acquisition module 230 may acquire a user voice through the microphone 140. The user voice acquisition module 230 may perform pre-processing for an audio signal received through the microphone 140. Specifically, the user voice acquisition module 230 may receive an audio signal in an analog form including a user voice through the microphone, and convert the analog signal into a digital signal. Also, the user voice acquisition module 230 may convert a user voice in a form of audio data into text data. Here, the user voice acquisition module 230 may include an acoustic model and a language model. The acoustic model may include information related to vocalization, and the language model may include information on unit phoneme information and combinations of unit phoneme information. The user voice acquisition module 230 may convert a user voice into text data by using the information related to vocalization and the information on unit phoneme information. The information on the acoustic model and the language model may be stored, for example, in an automatic speech recognition database (ASR DB).

The intent analysis module 235 may perform syntactic analysis or semantic analysis based on text data regarding a user voice acquired through voice recognition, and identify a domain for the user voice and the user intent. Here, the syntactic analysis may divide a user input into syntactic units (e.g., words, phrases, morphemes, etc.), and identify which syntactic elements the divided units have. The semantic analysis may be performed by using semantic matching, rule matching, formula matching, etc. In particular, the intent analysis module 235 may acquire a result of natural language understanding, the category of the user voice, the intent of the user voice, and a slot (or, an entity, a parameter, etc.) for performing a task corresponding to the intent of the user voice.

The dialogue manager 240 may acquire response information for the user voice based on the user intent and the slot acquired by the intent analysis module 235. Here, the dialogue manager 240 may provide a response for the user voice based on the dialogue history 270 and the dialogue resource 275. Here, the dialogue history 270 may store information on the text uttered by the user and the slot, and the dialogue resource 275 may store the attributes of the slots for each user intent for dialogues. Here, the dialogue history 270 and the dialogue resource 275 may be included inside the robot 100, but this is merely an example, and it may be included in an external server.

Also, the dialogue manager 240 may determine whether the information on the slot acquired through the intent analysis module 235 is sufficient for performing a task corresponding to the user intent. As an example, the dialogue manager 240 may determine whether the slot acquired through the intent analysis module 235 is a form that can be interpreted by the robot system. For example, in a user voice “Go back to the previous location,” “the previous location” cannot be interpreted by the robot system. Thus, the dialogue manager 240 may determine that the slot is insufficient for performing a task corresponding to the user intent. As another example, the dialogue manager 240 may determine whether the slot acquired by the intent analysis module 235 is sufficient for performing a task corresponding to the user intent based on the attributes of the slots for each user intent stored in the dialogue resource 275. For example, in case a user intent is a phone call, the dialogue resource 275 may include a contact list in a slot for performing a phone call. Here, in the user voice “Please make a phone call,” a slot corresponding to the contact list (names or phone numbers) does not exist. Thus, the dialogue manager 240 may determine that the slot is insufficient for performing a task corresponding to the user intent.

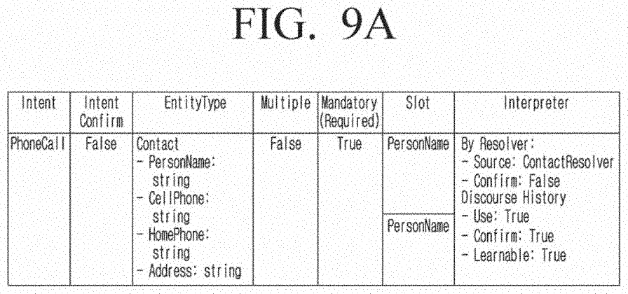

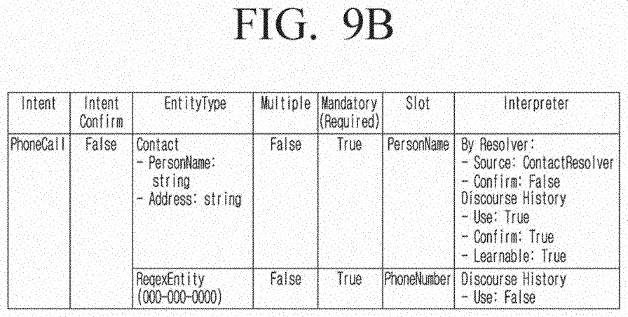

The dialogue resource 275 according to an embodiment of the disclosure may store attributes of slots for each user intent in various forms. For example, as illustrated in FIG. 9A, in case two slots (names and phone numbers) are designated as a group as slots for performing a task of “making a phone call,” the task of “making a phone call” can be performed just with one slot between “names” or “phone numbers” for performing the task of “making a phone call.” However, as illustrated in FIG. 9B, in case two slots (names and phone numbers) are designated independently as slots for performing the task of “making a phone call,” the task of “making a phone call” can be performed only when both of “names” and “phone numbers” exist for performing the task of “making a phone call.”

If it is determined that the information on the slot is sufficient for performing a task corresponding to the user intent, the dialogue manager 240 may store the information on the user intent and the information on the slot in the blackboard 250.

If it is determined that the information on the slot is insufficient for performing a task corresponding to the user intent, the dialogue manager 240 may acquire information on an additional slot necessary for performing the task corresponding to the user intent. Then, the dialogue manager 240 may store the information on the user intent, the information on the slot, and the information on the additional slot (including an additional inquiry and response operation) in the blackboard 250.

As an example, the dialogue manager 240 may convert the information on the slot into information in a form that can be interpreted by the robot 100, and acquire information on an additional slot. Here, the dialogue manager 240 may convert the information on the slot into information in a form that can be interpreted by the robot 100 by using the slot resolver 245, and acquire information on an additional slot. The slot resolver 245 may acquire a slot in a form that can be interpreted by the robot system from the information on the slot output by the intent analysis module 235 by using the data stored in the knowledge base 280. For example, after the first user voice “Come here,” if the second user voice “Go back to the previous location” is acquired, the slot resolver 245 may convert the slot “the previous location” into information on the actual absolute coordinate based on the data stored in the knowledge base 280. Here, the knowledge base 280 may be included inside the robot 100, but this is merely an example, and it may be included in an external server.

As another example, the dialogue manager 240 may acquire information on an additional slot based on the dialogue history 270. After the first user voice “There is Cheolsu's phone number,” if the second user voice “Please make a phone call” is acquired, the dialogue manager 240 may acquire Cheolsu's phone number as information on the slot of the contact list, based on the data stored in the dialogue history 270.

As still another example, the dialogue manager 240 may acquire information on a slot through an additional inquiry and response operation. Here, the additional inquiry and response operation may include a re-asking operation of inquiring about a slot necessary for performing a task corresponding to a user intent, a selection operation for selecting one of a plurality of slots, and a confirmation operation of confirming whether the slot is the slot selected by the user.

The dialogue manager 240 may store information on an additional inquiry and response operation in the blackboard area, and the behavior tree determination module 215 may acquire information on a behavior tree including a node for controlling a dialogue flow between the robot and the user based on the additional inquiry and response operation. For example, if the first user voice “Please order” is input, the dialogue manager 240 may store information for performing a re-asking operation of “Please tell me the menu” in the blackboard 250. Then, if the second user voice “One hamburger, one Coke, and one french fries” is input, the dialogue manager 240 may store information for performing a selection operation of “There are cheese burgers and bacon burgers. Which would you like to order?” in the blackboard 250. Further, if the third user voice “Cheese burger” is input, the dialogue manager 240 may store information for performing a confirmation operation of “Is one cheese burger correct?” in the blackboard 250. Here, the control module 220 may perform a re-asking operation, a selection operation, and a confirmation operation, etc. by controlling the NLG module 260 based on the information stored in the blackboard 250.

Also, the dialogue manager 240 may train regarding whether a slot for performing a task corresponding to the user intent can be acquired based on the slot of the previous dialogue recorded in the dialogue history 270. Here, the dialogue manager 240 may perform training based on whether a task corresponding to the user intent succeeded or a user feedback.

For example, in case setting of training is set as True inside the dialogue history 270, the dialogue manager 240 may perform training regarding a slot reuse. For example, if the first user voice “What is the phone number of Kim Samsung?” is input, the dialogue manager 240 may provide the first response “The phone number of Kim Samsung is xxxx-xxxx” as a response to the first user voice. Then, if the second user voice “Please make a phone call” is input, the dialogue manager 240 may confirm whether it is a slot reuse through a response “Is Kim Samsung correct?” as confirmation for the second user voice. Here, if the third user voice “Yes” is input, the dialogue manager 240 may train such that credibility for the slot reuse becomes high, and if the third user voice “No” is input, the dialogue manager 240 may train such that credibility for the slot reuse becomes low.

As still another example, if the second user voice “Please make a phone call” is input, the dialogue manager 240 may provide the second response “I'll call Kim Samsung” as a response to the second user voice. In the aforementioned situation, the dialogue manager 240 may acquire credibility regarding the slot reuse based on the user's feedback. That is, if there is no feedback from the user or a positive feedback (e.g., “Yes”) is input, the dialogue manager 240 may train such that credibility for the slot reuse becomes high, and if a negative feedback (e.g., Park Samsung but not Kim Samsung) is input, the dialogue manager 240 may train such that credibility for the slot reuse becomes low.

The dialogue manager 240 may identify whether a slot is reused based on the training result.

Also, the dialogue manager 240 may determine whether the user's intent identified by the intent analysis module 235 is clear. Here, in case the user's intent is not clear, the dialogue manager 240 may perform a feedback of requesting necessary information to the user.

The sensing module 255 may acquire information on the surroundings of the robot 100 and information on the user by using the sensor 160. Specifically, the sensing module 255 may acquire an image including the user, the distance to the user, the movement of the user, the biometric information of the user, obstacle information, etc. by using the sensor 160. The information acquired by the sensing module 255 may be stored in the blackboard 250.

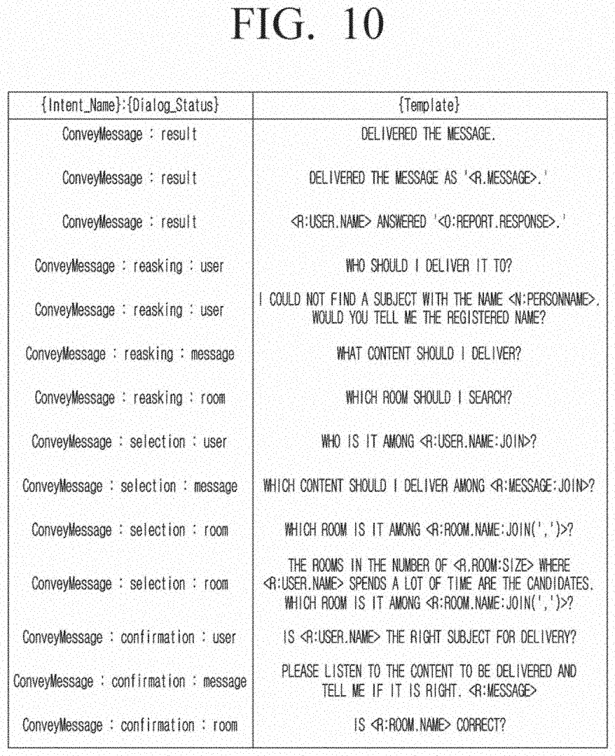

The NLG module 260 may change response information acquired through the dialogue manager 240 into a text form. The information changed to a text form may be in the form of utterance of a natural language. Here, the NLG module 260 may change the information into a text in the form of utterance of a natural language based on the NLG template 285. For example, as illustrated in FIG. 10, the NLG template 285 may be stored. Here, in the NLG template 285, r may indicate a semantic object (a result object of a resolver action), n may indicate a semantic frame (an input of interpretation), and o may indicate an output of an intent of an object.

The information changed into a text form may be changed into a voice form by a TTS module included in the robot, and output through the speaker 150, and output through the display.

According to an embodiment of the disclosure as described above, the robot 100 is controlled by systemically combining a behavior tree and control of a dialogue flow, and accordingly, the robot 100 becomes capable of performing a task or providing a response more actively to suit an environmental change of the robot 100 or a change in a user's needs.

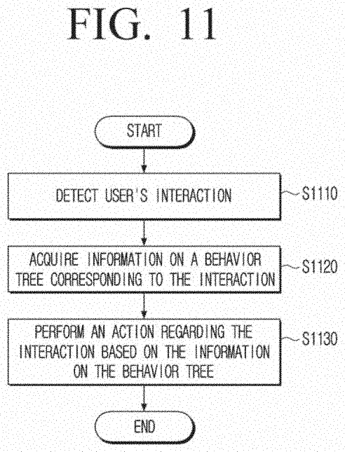

FIG. 11 is a flow chart for illustrating a controlling method of a robot according to an embodiment of the disclosure.

The robot 100 detects a user's interaction in operation S1110. Here, the user's interaction may be a user voice, but this is merely an example, and the user's movement or a change in the user's facial expression may also be included.

The robot 100 acquires information on a behavior tree corresponding to the interaction in operation S1120. Specifically, the robot 100 may acquire the information on the behavior tree based on data detected by the robot, data regarding the user's interaction, and data regarding an action performed by the robot. Here, the behavior tree may include a node for controlling a dialogue flow between the robot and the user. For example, the behavior tree may include a node for performing at least one of a re-asking operation of inquiring about a slot necessary for performing a task corresponding to the user intent, a selection operation for selecting one of a plurality of slots, and a confirmation operation of confirming whether the slot is the slot selected by the user.

The robot 100 performs an action regarding the interaction based on the information on the behavior tree in operation 51130. Specifically, the robot 100 may perform a task corresponding to the interaction by performing an action or providing a response according to the node included in the behavior tree.

The behavior tree stored in the robot 100 may include at least one of a learnable selector node that is trained to select an optimal sub tree/node among a plurality of sub trees/nodes, a learnable sequence node that is trained to select an optimal order of the plurality of sub trees/nodes, or a learnable parallel node that is trained to select optimal sub trees/nodes that can perform tasks simultaneously among the plurality of sub trees/nodes.

Methods according to the various embodiments of the disclosure may be provided while being included in a computer program product. A computer program product refers to a product, and it can be traded between a seller and a buyer. A computer program product can be distributed in the form of a storage medium that is readable by machines (e.g., a compact disc read only memory (CD-ROM)), or distributed directly on-line (e.g., download or upload) through an application store (e.g., Play Store™), or between two user devices (e.g., smartphones). In the case of on-line distribution, at least a portion of a computer program product (e.g., a downloadable app) may be stored in a storage medium readable by machines such as the server of the manufacturer, the server of the application store, and the memory of the relay server at least temporarily, or may be generated temporarily.

Also, the methods according to the various embodiments of the disclosure may be implemented as software including instructions stored in a machine-readable storage medium that is readable by machines (e.g., computers). Here, the machines refer to devices that call instructions stored in a storage medium, and can operate according to the called instructions, and the devices may include the electronic device (e.g., the robot 100) according to the aforementioned embodiments.

A storage medium that is readable by machines may be provided in the form of a non-transitory storage medium. Here, the term ‘a non-transitory storage medium’ only means that the device is a tangible device, and does not include a signal (e.g., an electronic wave), and the term does not distinguish a case wherein data is stored semi-permanently in a storage medium and a case wherein data is stored temporarily. For example, ‘a non-transitory storage medium’ may include a buffer wherein data is temporarily stored.

In case an instruction is executed by a processor, the processor may perform a function corresponding to the instruction by itself, or by using other components under its control. An instruction may include a code that is generated or executed by a compiler or an interpreter.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. A robot comprising:
a memory configured to store at least one instruction; and
at least one processor configured to execute the at least one instruction to:
based on detecting a user interaction, acquire information on a behavior tree corresponding to the user interaction, and
perform an action corresponding to the user interaction based on the information on the behavior tree,
wherein the behavior tree comprises a node for controlling a dialogue flow between the robot and a user.

2. The robot of claim 1, wherein the memory comprises:
a blackboard area configured to store data comprising data detected by the robot, data regarding the user interaction, and data regarding the action performed by the robot, and
the at least one processor is further configured to execute the at least one instruction to:
acquire the information on the behavior tree corresponding to the user interaction based on the data stored in the blackboard area.

3. The robot of claim 2, wherein the user interaction comprises a user voice, and
the at least one processor is further configured to execute the at least one instruction to:
acquire information on a user intent corresponding to the user voice and information on a slot for performing an action corresponding to the user intent,
determine whether the information on the slot is sufficient for performing a task corresponding to the user intent,
based on determining that the information on the slot is insufficient for performing the task corresponding to the user intent, acquire information on an additional slot necessary for performing the task corresponding to the user intent, and
store, in the blackboard area, the information on the user intent, the information on the slot, and the information on the additional slot.

4. The robot of claim 3, wherein the at least one processor is further configured to execute the at least one instruction to:
convert the information on the slot into information in a form that can be interpreted by the robot, and
acquire information on the additional slot based on a dialogue history or through an additional inquiry and response operation.

5. The robot of claim 4, wherein the additional inquiry and response operation comprises a re-asking operation comprising an inquiry regarding the slot for performing the task corresponding to the user intent, a selection operation configured to select one of a plurality of slots, and a confirmation operation configured to confirm whether the slot is the slot selected by the user, and
wherein the at least one processor is further configured to execute the at least one instruction to:
store information on the additional inquiry and response operation in the blackboard area, and
acquire information on the behavior tree including a node for controlling a dialogue flow between the robot and the user based on the additional inquiry and response operation.

6. The robot of claim 4, wherein the at least one processor is further configured to execute the at least one instruction to:
based on either the task being successfully performed or a user feedback, learn whether to acquire the information on the additional slot based on the dialogue history.

7. The robot of claim 1, wherein the behavior tree comprises at least one of: a learnable selector node that is trained to select an optimal sub tree/node among a plurality of sub trees/nodes, a learnable sequence node that is trained to select an optimal order of the plurality of sub trees/nodes, or a learnable parallel node that is trained to select optimal sub trees/nodes that can perform simultaneously among the plurality of sub trees/nodes.

8. The robot of claim 7, wherein the at least one processor is further configured to execute the at least one instruction to train the learnable selector node, the learnable sequence node, and the learnable parallel node based on a task learning policy, and
wherein the task learning policy comprises information on an evaluation method, an update cycle, and a cost function.

9. A method of controlling a robot, the method comprising:
based on detecting a user interaction, acquiring information on a behavior tree corresponding to the user interaction; and
performing an action corresponding to the user interaction based on the information on the behavior tree,
wherein the behavior tree comprises a node for controlling a dialogue flow between the robot and a user.

10. The method of claim 9, wherein the acquiring information on the behavior tree corresponding to the user interaction comprises acquiring information on the behavior tree corresponding to the user interaction based on data stored in a blackboard memory area of the robot, and
wherein the data stored in the blackboard memory area of the robot comprises data detected by the robot, data regarding the user interaction, and data regarding the action performed by the robot.

11. The method of claim 10, wherein the user interaction comprises a user voice, and
wherein the method further comprises:
acquiring information on a user intent corresponding to the user voice and information on a slot for performing an action corresponding to the user intent;
determining whether the information on the slot is sufficient for performing a task corresponding to the user intent;
based on determining that the information on the slot is insufficient for performing the task corresponding to the user intent, acquiring information on an additional slot necessary for performing the task corresponding to the user intent; and
storing, in the blackboard memory area, the information on the user intent, the information on the slot, and the information on the additional slot.

12. The method of claim 11, wherein the acquiring information on an additional slot comprises:
converting the information on the slot into information in a form that can be interpreted by the robot; and
acquiring information on the additional slot based on a dialogue history or through an additional inquiry and response operation.

13. The method of claim 12, wherein the additional inquiry and response operation comprises a re-asking operation comprising an inquiry regarding the slot for performing the task corresponding to the user intent, a selection operation configured to select one of a plurality of slots, and a confirmation operation configured to confirm whether the slot is the slot selected by the user, and
wherein the acquiring information on the behavior tree further comprises:
storing, in the blackboard memory area, information on the additional inquiry and response operation; and
acquiring information on the behavior tree including a node for controlling a dialogue flow between the robot and the user based on the additional inquiry and response operation.

14. The method of claim 12, further comprising:
based on either the task being successfully performed or a user feedback, learning whether to acquire the information on the additional slot based on the dialogue history.

15. The method of claim 9, wherein the behavior tree comprises at least one of: a learnable selector node that is trained to select an optimal sub tree/node among a plurality of sub trees/nodes, a learnable sequence node that is trained to select an optimal order of the plurality of sub trees/nodes, or a learnable parallel node that is trained to select optimal sub trees/nodes that can perform simultaneously among the plurality of sub trees/nodes.
